(19) United States
(12) Patent Application Publication
(10) Pub. No.: US 2010/0225024 A1
(43) Pub. Date: Sep. 9, 2010

(54) FORMING DEVICE AND METHOD FOR CREATING A RECESS WHEN CASTING A PART

(75) Inventor: Nikolaus Wild, Friedrichsdorf (DE)

Correspondence Address: VOLPE AND KOENIG, P.C., UNITED PLAZA, 30 SOUTH 17TH STREET, PHILADELPHIA, PA, 19103, US

(73) Assignee: SCHOCK BAUTEILE GMBH, Baden-Baden (DE)

(21) Appl. No.: 12/713,456

(22) Filed: Feb. 26, 2010

(30) Foreign Application Priority Data
Mar. 4, 2009 (DE) 102009011616.8

(51) Int. Cl. B29C 39/10

(52) U.S. Cl. 264/279; 249/1

(57) ABSTRACT

A forming device (4) is provided to create a recess when casting a part (1), particularly made from site-cast concrete. The forming device (4) is includes elements (6, 7, 10) that allow a subsequent fastening of a tensile stress compensating element (3) in the area of the recess by filling in a curing and/or curable filler, particularly concrete. Furthermore, an appropriate method is suggested, which includes the processing steps: limiting an area corresponding to the recess using a formwork, particularly using the forming device (4); arranging elements (6, 7), particularly at least one reinforcement element in the area of the recess, which allow for a subsequent fastening of an element (3) to compensate tensile stress in the area of the recess by filling in a curing and/or curable filler, particularly concrete, with the elements (6, 7) extending through the formwork inside the limited area and outside the limited area in the direction of the part (1); and casting the part (1).

### CROSS-REFERENCE TO RELATED APPLICATIONS

This application claims the benefit of German Patent application No. 10 2009 011 616.8, filed Mar. 4, 2009, which is incorporated herein by reference as if fully set forth.

### BACKGROUND

The present invention relates to a forming device for creating a recess when casting a part, particularly made from site-cast concrete.

Furthermore, the present invention relates to a method for creating a recess when casting a part, particularly made from site-cast concrete.

In the field of structural engineering it regularly occurs that a part, particularly cast on-site from concrete, such as a concrete ceiling or the like, shall laterally be connected in a tensile stress resistant manner to another element. Here, a first approach particularly provides for a number of bores to be entered into the cast part and then to anchor the respective element in said bores. However, on the one hand this process has proven to be relatively expensive, and on the other hand it is limited with regard to the tensile stress that can be compensated.

Another approach provides to already appropriately position the element to compensate the tensile stress when casting the part and then at least partially to integrate it during the casting process of the part. This procedure allows the compensation of higher tensile stress, however it regularly occurs, for example when the respective elements are to be provided at the exterior of a building, that at least portions of the respective element project therefrom, which aggravates or even prevents the erection of scaffolding.

Therefore a solution is necessary that allows fastening of elements to compensate for tensile stress subsequently, i.e. after the production of the part, without requiring the insertion of bores into the part and/or without resulting in any projections from said part.

### SUMMARY

The invention is based on the object to further develop a forming device of the type mentioned at the outset and/or a method of the type mentioned at the outset such that the subsequent fastening of an element compensating tensile stress is allowed for a cast part without inserting any bores and without any elements projecting from said part.

The object is attained with a forming device having the features of the invention and in a method according to the invention.

Additional further developments of the invention are described below and in the claims, with their wording here explicitly being included by way of reference in order to avoid any unnecessary repetitions of text.

According to the invention, a forming device for creating a recess when casting a cast part, particularly comprising site-cast concrete, is characterized in means allowing a subsequent fastening of elements compensating tensile stress in the area of said recess by filling in a curing and/or curable filler, particularly concrete.

Furthermore, a method according to the invention for creating a recess when casting a part, particularly comprising site-cast concrete, is characterized in the following processing steps: limiting a section equivalent to the recess using a formwork, particularly while using a forming device according to the invention; arranging means, particularly at least one reinforcing element, allowing a subsequent fastening of an element compensating tensile stress in the area of the recess by filling in a curing and/or curable filler, particularly concrete, with the means particularly extending in the direction of the part through the mold, on the one side, inside the defined area, and on the other side, outside the defined area, and casting the part outside the formwork

The element compensating tensile stress according to the customary interpretation of the present invention particularly relates to an element of the type Isokorb® of the company of the applicant. In order to subsequently connect it to the part in a manner capable to compensate tensile stress the forming device according to the invention is used to create a recess when casting the part, in which the element compensating the tensile stress can be fastened subsequently by it being inserted into the recess, at least partially, and by subsequently the recess being filled with a curing and/or curable filler.

According to the invention the forming device comprises particular means in a novel manner, allowing that the fastened and/or to be fastened element ultimately can actually compensate tensile stress.

In a first further development of the forming device according to the invention it is provided for said purpose that the forming device is essentially embodied in the form of a box and that the means comprise at least one penetration or at least one predetermined penetration point at least at one wall of the box, through which penetration at least one reinforcement element of the part can be inserted into the free space inside the box.

The above-described further development utilizes that during the production of parts made from site-cast concrete regularly reinforcement elements, particularly made from metal (steel), are provided inside the part in the form of reinforcement rods or the like. When now the forming device comprises at least one (predetermined) penetration point when the forming device is positioned such a reinforcement element can be inserted in the free space inside thereof, with subsequently during the introduction of the curing filler a connection can be created in the area of the recess that can carry tensile stress.

Of course, the forming device may comprise a multitude of such (predetermined) penetration points in order to allow a corresponding number of reinforcement elements to be inserted into the free space inside the box.

The above-mentioned reinforcement elements may represent lateral and/or longitudinal reinforcement elements of a part. They may be embodied straight and/or angled. The (predetermined) penetration points of the forming device are then embodied and/or arranged accordingly.

Another further development of the forming device according to the invention provides that a number of (predetermined) penetration points of the forming device are arranged at least in two opposite walls of the forming device embodied as a box. When the above-mentioned penetration points are additionally arranged symmetrically aligned in a common plane they are particularly suitable for guiding straight reinforcement elements of the part through the forming element. The above-mentioned straight reinforcement elements may particularly represent lateral reinforcement elements of the part.

Another further development of the forming device according to the invention provides, however, that the (predetermined) penetration points are arranged at least in two adjacent walls of the box, for example at a lateral wall and the bottom of the box. Here, it may further be provided that the above-mentioned penetrations are arranged symmetrically in reference to each other, with in this context the term “symmetry” describing the number and relative positioning of the (predetermined) penetrations in reference to each other. This way the forming device is particularly suitable for guiding angular reinforcement elements of the part through the box.

In order to facilitate the passing of reinforcement elements through the forming device both in the lateral as well as the longitudinal direction and/or to even allow it in the first place another further development of the forming device according to the invention provides for the box to be comprised of at least two box parts, which may be connected to each other in a hinged fashion, in particular. Here, the separating line between the box parts preferably extends in the plane in which the (predetermined) penetrations are arranged as well, as described above. Most preferably, all (predetermined) penetrations are arranged in the lateral walls of the box, at least essentially in a common plane.

A generally differently aspect of the forming device according to the invention is provided in that the above-mentioned means are not embodied in the form of (predetermined) penetrations but they themselves comprise at least one projecting structure, which in the manner of the reinforcement elements already mentioned several times, projects on one side into the free space inside the box and on the other side projects from the exterior surface of the box towards the outside in the direction of the part. In other words: within the scope of the above-described embodiment of the forming device according to the invention it is no longer necessary to guide reinforcement elements of the part into the forming device or passing them therethrough but the forming device itself comprises at least one corresponding reinforcement element, which projects both inwardly into the forming device as well as outwardly in the direction of the part and accordingly is also encased in this area when the part is cast.

Advantageously the above-mentioned projecting structure shows a minimum measurement in reference to a corresponding dimension of the free space inside the box and here particularly does not extend beyond the free space inside the box, which otherwise would lead to the projection problems described further above.

A particular further development of the forming device according to the invention provides that it is made from cardboard or the like. Most preferably, the cardboard material of the forming device is at least sectionally treated or coated to be moisture repellent.

Alternatively the forming device may also be embodied from plastic, preferably polystyrene.

Another further development of the forming device according to the invention provides that it is made from a metallic material and in this context particularly assumes the form of a sheet metal grid or expanded metal.

In order to improve the connection between the forming device, on the one side, and the material of the part or the filler material, on the other side, another further development of the forming device according to the invention provides that said device comprises, at least sectionally and particularly at its exterior facing the part, a defined roughness for connecting to the part. This may occur particularly by providing the above-mentioned coating.

As discernible for one trained in the art, it is unnecessary, particularly when the forming device is embodied from an easily processed material, such as cardboard or plastic, to predetermine any defined positions for the (predetermined) penetrations. Rather, they may be created quite arbitrarily on site depending on the number, type, and position of the reinforcement elements.

### BRIEF DESCRIPTION OF THE DRAWINGS

Additional advantages and features of the present invention are discernible from the following description of exemplary embodiments using the drawing.

FIG. 1 shows schematically the use of a forming device according to the invention during the production of a part cast from in-situ concrete;

FIG. 2 is a cross-sectional view, taken approximately along the line II-II in FIG. 1;

FIG. 3 is a cross-sectional view, taken approximately along the line III-III in FIG. 1;

FIG. 4 shows the forming device of FIG. 1 in a separated state and prior to the insertion of an element compensating tensile stress.

### DETAILED DESCRIPTION OF THE PREFERRED EMBODIMENTS

In all figures, identical or equivalent elements are marked with the same reference characters.

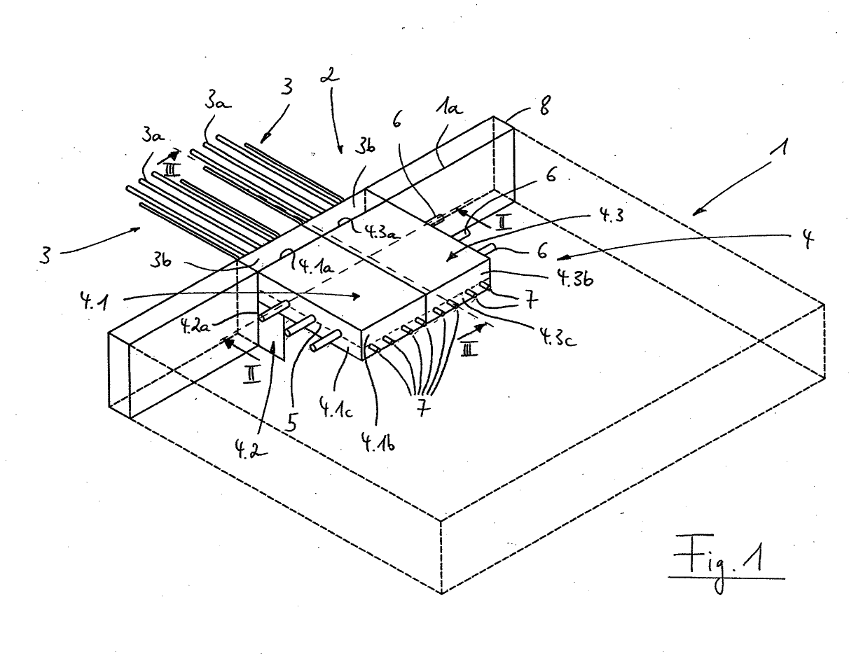

In FIG. 1, a cast part, particularly produced and/or to be produced from site-cast concrete, for example a concrete ceiling, is marked with the reference character 1. Alternatively, reference character 1 may also mark only the spatial area in which the respective part shall be produced by way of casting, particularly from site-cast concrete.

At another side of the part 1, marked with the reference character 2 in FIG. 1, a recess shall be created (not marked as such), in which subsequently, i.e. after the production of the part 1, an element 3 shall be fastened that is used for compensating tensile stress, by the tensile stress compensation element 3 being partially inserted into the recess and said (recess) then being filled with a curing and/or curable filler, particularly concrete.

The tensile stress compensating element 3 represents, in case of the exemplary embodiment according to FIG. 1, several individual elements of the type Isokorb® of the company of the applicant, of which a number of reinforcement elements 3a as well as insulating elements 3b facing the part 1 are each discernible in the illustration according to FIG. 1.

In order to create the recess, within the scope of the present invention, the use of a special forming device 4 is provided, with its embodiment being explained in greater detail in the following.

The forming device 4, according to FIG. 1 comprises a multitude of box-shaped and/or cube-shaped elements 4.1, 4.2, 4.3, with another element (4.4) equivalent to the box 4.2 not being discernible below the box 4.3 for reasons of clarity. The larger box elements 4.1, 4.3 are embodied identical and are arranged side-by-side in reference to each other such that their two short faces (4.1a, 4.3a) are aligned to the frontal edge 1a of the part 1. At least in one spatial direction the other box elements 4.2 comprise a smaller dimension than the box elements 4.1, 4.3. The former ones are arranged side-by-side in reference to each other and below the box elements 4.1, 4.3 such that they are each aligned with one of their sides 4.2a, over the entire joint face 4.1a, 4.3a of the box elements 4.1, 4.3, to the frontal edge 1a of the part 1 such that overall a L-shaped cross-sectional profile of the forming device 4 results, without the invention being limited to such a type of arrangement of box elements and/or to such a form of forming devices.

The box elements 4.1, 4.3 are each comprised of one upper box element 4.1b, 4.3b and one lower box element 4.1c, 4.3c, with the upper and the lower box elements being combined along a separating line 5.

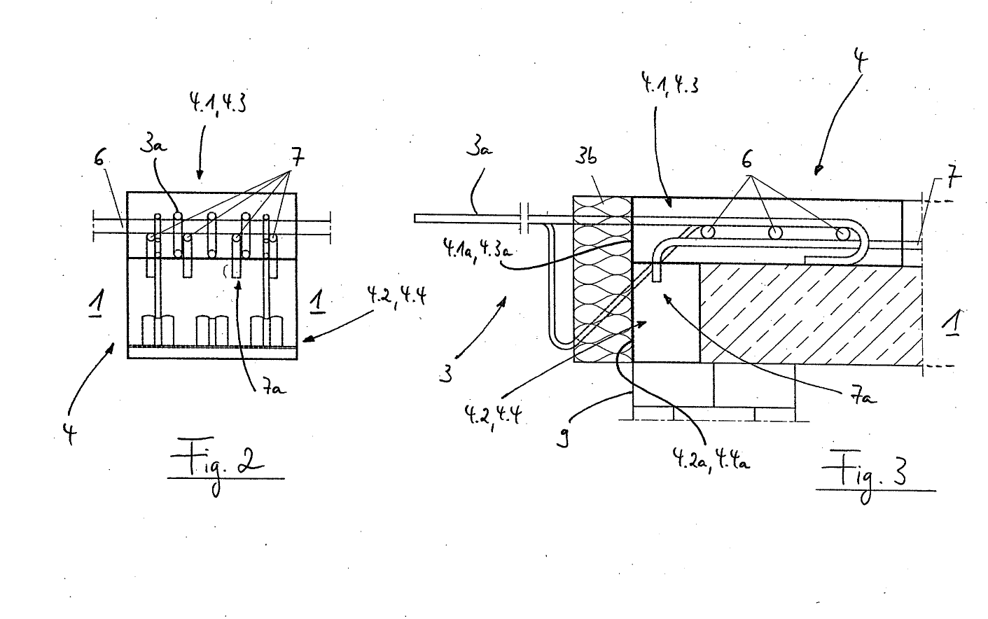

From the area of the part 1, the reinforcement elements 6. 7 extend into the recess section defined by the forming device 4, which is explained in greater detail in the following using FIGS. 2 through 4. The reinforcement elements 6 represent so-called lateral reinforcements, while the reinforcement element 7 represent so-called longitudinal reinforcements.

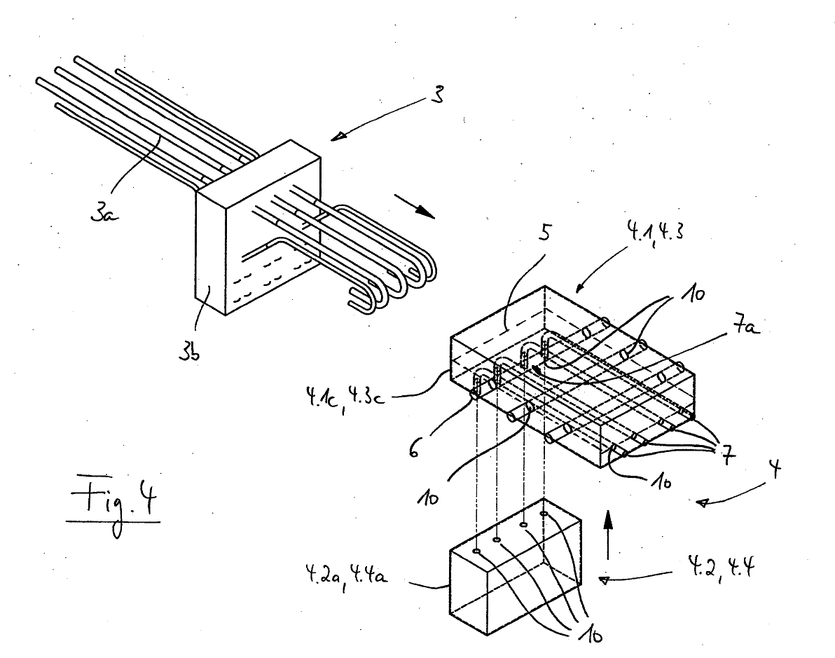

At the frontal edge 1a of the part 1 an additional (building) insulation 8 is discernible at the side of the insulating elements 3b, which is irrelevant within the scope of the present invention, though. In FIG. 3 an exterior masonry building wall is shown, marked with the reference character 9, with the part 1 resting thereupon being embodied as a concrete ceiling.

FIG. 2 shows a cross-section approximately along the line II-II in FIG. 1. However, in the illustration according to FIG. 2 only one upper box element 4.1, 4.3 and only one lower box element 4.2, 4.4 are shown. In FIG. 2 a lateral reinforcement element 6 is well discernible as are a number of longitudinal reinforcement elements 7, which at their rear end 7a are bent downwards and extend into the area of the lower box element 4.2, 4.3. With the reference characters 3a, in turn, reinforcement elements are shown of the tensile stress compensating elements 3 (cf. FIG. 1.)

FIG. 3 shows a cross-section approximately along the line III-III in FIG. 1. In FIG. 3 the progression of the lateral reinforcement elements 7 and the progression of the reinforcement elements 3a of the tensile stress compensating elements 3 are particularly well discernible in the area of the recess. According to FIG. 2 and FIG. 3, the reinforcement elements 6, 7 extend from the area of the part 1 to the area of the recess defined by the forming device 4 and/or, in case of the lateral reinforcement elements 6, even entirely through the area of the recess.

The reinforcement elements 3a of the tensile stress compensating element are also arranged in the part 1, in the area of the recess defined by the forming device 4, such that the tensile stress compensating element 3 after the recess has been filled with a curing and/or curable filler, such as concrete, is actually suitable to compensate tensile stress.

By providing several box elements 4.1-4.4 side-by-side and/or over top of each other (cf. FIG. 1), recesses of any arbitrary shape and/or size may be created in general so that quasi any and particularly any arbitrary number of tensile stress compensating elements 3 can be subsequently fastened at the part 1.

The present invention provides the essential advantage that only based on the recess created, the subsequent fastening of the elements compensating tensile stress becomes possible so that initially during the production of the part 1 no elements project from its front edge 1a. This is of particular importance in the field of structural engineering, when for example part 1 represents a concrete ceiling, in order to then allow a scaffolding to be positioned in the area of the frontal edge 1a of the part, without any interference developing by projecting reinforcement elements, such as the reinforcement elements 3a according to FIG. 1.

FIG. 4 shows additional details of the forming device 4 according to the invention. As particularly well discernible in the box element 4.2, 4.4 the forming device 4 comprises a number of penetrations 10, by which it is inserted onto the (angular) ends 7a of the longitudinal reinforcement element 7 such that the ends mentioned protrude into the interior of the box element 4.2, 4.4. At the box element 4.1, 4.3, respective penetrations 10 to be penetrated by the reinforcement elements 6, 7 are provided around it, with in the present case only some of them being marked as examples, for reasons of clarity. The penetrations 10 for the lateral reinforcement elements 6 are arranged in opposite lateral walls of the box element 4.1, 4.3, aligned in reference to each other as shown in FIG. 4. For the longitudinal reinforcement elements 7, there are penetrations 10 in neighboring walls (here: lateral wall and floor) of the box element 4.1, 4.3 so that the longitudinal reinforcement elements 7 can be inserted laterally into the box 4.1, 4.3 and then exit it again in the area of the respective penetrations 10 with their angular ends 7a at the bottom of the box 4.1, 4.3, in order to then enter into the box 4.2, 4.4, as already described. However, within the scope of the invention it is also possible to embody the upper box 4.1, 4.3 such that the longitudinal reinforcement elements 7 with their ends 7a are completely accepted therein. Here, the additional box 4.2, 4.4 would be unnecessary.

A particular facilitating benefit develops when, in order to allow arranging the forming device 4, particularly the box elements 4.1, 4.3, prior to the production of the part 1 but after the arrangement of the reinforcement 6, 7, the box elements 4.1, 4.3, as illustrated, can be separated at the separation line 5 so that first the lower box part 4.1c, 4.3c is inserted from the bottom onto the angular ends of the longitudinal reinforcement element 7, and is now made to contact the lateral reinforcement elements 6 from the bottom with the approximately halved penetrations 10 of the reinforcement level. Subsequently the upper box part 4.1b, 4.3b is put thereupon in order to form, together with the lower box part 4.1c, 4.3c, the box element 4.1, 4.3, as shown in FIG. 4. Said element is held in its position by the reinforcement elements 6, 7. Subsequently the box element 4.2, 4.4 is inserted onto the angular ends 7a of the longitudinal reinforcement elements 7 in the manner shown.

The penetrations 10 can already be formed in the forming device 4 in advance. Alternatively it is possible to provide a number of predetermined penetration points in the lateral walls of the forming device 4, which can then be opened, depending on the position and/or the geometry of the reinforcement elements 6, 7, to become penetrations 10.

When the forming device 4 is embodied from a material easily processed, such as cardboard or plastic (polystyrene) the provision of predetermined penetration points can even be waived, and the penetrations 10 are created entirely arbitrary depending on the requirements on site with the help of a suitable tool (knife, screwdriver, or the like.)

After the forming device 4, as described above using the FIGS. 1 through 4, has been embodied and/or arranged in the area of the part 1 to be cast, the area 1 is cast according to FIG. 1, particularly (filled) with in-situ concrete. This way, in the edge region of the part 1, a recess remains of the shape defined by the forming device 4, within which the reinforcement elements 6, 7 are exposed, at least partially, while they are encased in the part 1, on the other side. When the forming device 4, i.e. the box elements 4.1-4.4 is/are not embodied open towards the outside in the area of the front edge 1a of the part subsequently the shuttering material is removed at least in this area, and the element 3 compensating the tensile stress can be inserted with its reinforcement elements 3a into the area of the recess. This is then filled with the curing and/or curable filler, particularly concrete, so that a connection withstanding tensile stress develops between the element 3 and the part 1 in the area of the (former) recess.

A multitude of variations of the exemplary embodiments according to the FIGS. 1 through 4 are possible without departing from the object of the present invention according to the attached claims.

For example, it is not mandatory for the reinforcement elements 6, 7 to represent reinforcement elements of the part 1, rather the reinforcement elements 6, 7 may be a component of the forming device 4. In this case, they are directly connected to the lateral walls of the box elements 4.1, 4.3 in the above-described form and arrangement. This way, the potentially cumbersome threading of the reinforcement elements 6, 7 through the forming device 4 is omitted.

Furthermore, the forming device 4 does not necessarily need to be comprised of a multitude of box elements but it may be embodied in one piece and in any arbitrary geometry as long as during its application the desired recess is created to fasten the elements compensating the tensile stress.

Furthermore, particularly the reinforcement elements 6, 7 are not limited to the shape, arrangement, and alignment shown in the figures as examples.

As already explained, it may be advantageous if a forming device 4 is embodied open at the side arranged at the front edge 1a of the part, i.e. the box elements 4.1, 4.3 and/or 4.2, 4.4 have no lateral wall 4.1a, 4.3a, and/or 4.2a, 4.4a. This way, it is no longer necessary, after the casting of the part 1 and prior to the insertion of the elements 3 compensating the tensile stress, to create an appropriate opening in the forming device 4, which can be cumbersome particularly when the forming device 4 according to a particular embodiment of the present invention is embodied from a metallic material, preferably like an expanded metal or sheet metal grid.

1. A forming device (4) for creating a recess when casting a part (1), comprising a formwork having means (10) for receiving reinforcement elements (6, 7) that allow a subsequent fastening of tensile stress compensating elements (3) in an area of the recess using a curing and/or curable filler.

2. A forming device (4) according to claim 1, wherein the formwork comprises a box (4.1-4.4) and the means for receiving elements that allow a subsequent fastening of the tensile stress compensating elements comprise at least one penetration (10) or at least one predetermined penetration point in at least one box wall of the box, through which at least one of the reinforcement elements (6, 7) of the part (1) can be inserted into an open space inside the box (4.1-4.4).

3. A forming device (4) according to claim 2, wherein the at least one penetration (10) or the predetermined penetration point comprise multiple penetrations or penetration points arranged in at least two opposite box walls, symmetrically aligned in a common plane, for guiding straight reinforcement elements (6) of the part (1) through the box (4.1, 4.3).

4. A forming device (4) according to claim 3, wherein the penetrations (10) or predetermined penetration points are arranged in at least two adjacent box walls, symmetrically in reference to each other, for guiding angular reinforcement elements (7) of the part (1) through the box (4.1, 4.3).

5. A forming device (4) according to claim 3, wherein the box (4.1, 4.3) is comprised of at least two hinged box parts (4.1a, 4.1b, 4.3a, 4.3b), with a separating line (5) extending between the box parts (4.1a, 4.1b; 4.3a, 4.3b) in the common plane.

6. A forming device (4) according to claim 1, wherein the formwork comprises a box (4.1-4.4), and the forming device further comprising at least one reinforcing element (6, 7), which on the one side projects into a free space inside the box (4.1-4.4) and which on an other side projects outside from the box (4.1-4.4) outwardly in a direction of the part (1).

7. A forming device (4) according to claim 6, wherein the reinforcing element is embodied as an angular reinforcement element (6, 7).

8. A forming device (4) according to claim 6, wherein the reinforcing element includes a projecting structure that has a minimum dimension in reference to a corresponding dimension of a free space inside the box (4.1-4.4) and does not extend beyond the free space inside the box (4.1-4.4).

9. A forming device (4) according to claim 1, wherein the formwork is made from cardboard.

10. A forming device (4) according to claim 1, wherein the formwork is made from plastic.

11. A forming device (4) according to claim 1, wherein the formwork is made from a metallic material.

12. A forming device (4) according to claim 1, wherein the formwork is at least one of partially waterproofed or coated with a coating.

13. A forming device (4) according to claim 12, wherein the formwork, at least partially includes a roughened outer surface for a connection to a part (1) with the roughened outer surface being provided by the coating.

14. A forming device (4) according to claim 1, wherein the formwork, at least partially includes a roughened outer surface for a connection to a part (1).

15. A method for creating a recess when casting a part (1) from concrete, comprising:
limiting an area according to the recess by way of a formwork having means (10) for receiving reinforcement elements (6, 7) that allow a subsequent fastening of tensile stress compensating elements (3) in an area of the recess using a curing and/or curable filler;
arranging at least one reinforcement element (6, 7) to allow a subsequent fastening of the tensile stress compensating element (3) in an area of the recess by filling in a curing and/or curable filler, with the reinforcement element (6, 7) extending inside a limited area through the formwork, and outside the limited area in a direction of the part (1); and
casting the part (1) outside the formwork.

16. A method according to claim 15, wherein prior to casting of the part (1), the reinforcing element is inserted into at least one of the free space inside the recess or through the free space inside the recess, by at least one part (4.1-4.4) of the formwork being pushed onto the reinforcement element (6, 7).

17. A method according to claim 15 wherein, when creating the formwork, at least one part (4.1-4.4) of the formwork is used having a projecting structure (6, 7), which extends on one side into the free space inside the formwork and on the other side from the formwork outwardly in a direction of the part (1).
